(19) United States
(12) Patent Application Publication
(10) Pub. No.: US 2016/0258302 A1
(43) Pub. Date: Sep. 8, 2016

(54) AIRFOIL AND METHOD FOR MANAGING PRESSURE AT TIP OF AIRFOIL

(71) Applicant: General Electric Company, Schenectady, NY (US)

(72) Inventors: Adebukola Oluwaseun Benson, Simpsonville, SC (US); Lisa De Bellis, Simpsonville, SC (US); Xiuzhang James Zhang, Simpsonville, SC (US)

(21) Appl. No.: 14/639,374

(22) Filed: Mar. 5, 2015

(51) Int. Cl. F01D 5/20; F01D 5/02; F01D 5/30; F01D 5/18

(52) U.S. Cl. CPC F01D 5/20; F01D 5/187; F01D 5/02; F01D 5/3007; F05D 2220/32; F05D 2220/31; F05D 2240/12; F05D 2240/307; F05D 2260/20; F05D 2250/711; F05D 2250/712; F05D 2230/60

(57) ABSTRACT

An airfoil includes a squealer tip at an outer radial end of the airfoil. A squealer tip pocket of the squealer tip has a convex side and a concave side, and a tip plate. A divider extends across the tip plate from the concave side to the convex side to divide the squealer tip pocket into a first pocket and a second pocket. At least one cooling passage through the tip plate in the second pocket provides fluid communication through the tip plate from an interior of the airfoil to the second pocket. The first pocket is fluidically disconnected from the interior of the airfoil.

### BACKGROUND OF THE INVENTION

The subject matter disclosed herein relates to an airfoil and a method of managing pressure at the tip of the airfoil.

Turbines are widely used in industrial and commercial operations. A typical commercial steam or gas turbine used to generate electrical power includes alternating stages of stationary and rotating airfoils or blades. For example, stator vanes are attached to a stationary component such as a casing that surrounds the turbine, and rotor blades are attached to a rotor located along an axial centerline of the turbine. A compressed working fluid, such as steam, combustion gases, or air, flows through the turbine, and the stator vanes accelerate and direct the compressed working fluid onto the subsequent stage of rotor blades to impart motion to the rotor blades, thus turning the rotor and performing work.

Compressed working fluid that leaks around or bypasses the rotor blades reduces the efficiency of the turbine. To reduce the amount of compressed working fluid that bypasses the rotor blades, the casing may include stationary shroud segments that surround each stage of rotor blades, and each rotor blade may include a tip cap at an outer radial tip that reduces the clearance between the shroud segments and the rotor blade. Although effective at reducing or preventing leakage around the rotor blades, the interaction between the shroud segments and the tip caps may result in elevated local temperatures that may reduce the low cycle fatigue limits and/or lead to increased creep at the tip caps. As a result, a cooling media may be supplied to flow inside each rotor blade before flowing through cooling passages in the tip cap to provide film cooling over the tip cap of the rotor blade.

In particular designs, each tip cap may include an outer surface or tip plate that is at least partially surrounded by a rim. The rim and the tip plate may at least partially define a tip cavity, also known as a squealer tip pocket, between the rim, the tip plate, and the surrounding shroud segments. In this manner, the cooling media supplied to the squealer tip pocket may remove heat from the tip cap before flowing over the rim and out of the squealer tip pocket.

### BRIEF DESCRIPTION OF THE INVENTION

According to one aspect of the invention, an airfoil includes a squealer tip at an outer radial end of the airfoil. A squealer tip pocket of the squealer tip has a convex side and a concave side, and a tip plate. A divider extends across the tip plate from the concave side to the convex side to divide the squealer tip pocket into a first pocket and a second pocket. At least one cooling passage through the tip plate in the second pocket provides fluid communication through the tip plate from an interior of the airfoil to the second pocket. The first pocket is fluidically disconnected from the interior of the airfoil.

According to another aspect of the invention, a rotor blade includes a dovetail operatively configured to connect to a rotor wheel and an airfoil. The airfoil includes a squealer tip at an outer radial end of the airfoil, a squealer tip pocket of the squealer tip having a convex side and a concave side, and a tip plate. A divider extends across the tip plate from the concave side to the convex side to divide the squealer tip pocket into a first pocket and a second pocket. At least one cooling passage through the tip plate in the second pocket provides fluid communication through the tip plate from an interior of the airfoil to the second pocket. The first pocket is fluidically disconnected from the interior of the airfoil.

According to yet another aspect of the invention, a method of managing pressure at a tip of an airfoil includes placing a divider across a tip plate in a squealer tip pocket of the airfoil from a concave side to a convex side of the tip to divide the tip pocket into a first pocket and a second pocket, fluidically blocking an interior of the airfoil from the first pocket, and fluidically connecting at least one cooling passage through the tip plate in the second pocket to provide fluid communication through the tip plate from an interior of the airfoil to the second pocket.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a simplified cross-section view of an embodiment of a turbine that may incorporate various embodiments of a rotor blade of the present invention;

FIG. 2 is a perspective view of a portion of an embodiment of a turbine stage shown in FIG. 1 having an embodiment of a rotor blade;

FIG. 3 is a schematic drawing illustrating an embodiment of openings in a low pressure section of the outer end of the rotor blade in comparison to an embodiment of flow pathways within the rotor blade;

FIG. 4 is a schematic drawing illustrating an embodiment of openings in a low pressure section of the outer end of the rotor blade in comparison to another embodiment of flow pathways within the rotor blade;

FIG. 5 is a top plan view of a squealer tip pocket of a rotor blade demonstrating a ratio of static pressure to inlet pressure across the pocket;

FIG. 6 is a top plan view of a squealer tip pocket of an embodiment of a rotor blade demonstrating a ratio of static pressure to inlet pressure across the pocket;

FIG. 7 is a top plan view of a squealer tip pocket of another embodiment of a rotor blade demonstrating a ratio of static pressure to inlet pressure across the pocket;

FIG. 8 is graph of pressure ratio versus location along the camber line of the rotor blades of FIGS. 5-7; and,

FIG. 9 is top plan view of an outer end of an embodiment of a rotor blade with a fluid access in the rim.

The detailed description explains embodiments of the invention, together with advantages and features, by way of example with reference to the drawings.

### DETAILED DESCRIPTION OF THE INVENTION

Reference will now be made in detail to present embodiments of the invention, one or more examples of which are illustrated in the accompanying drawings.

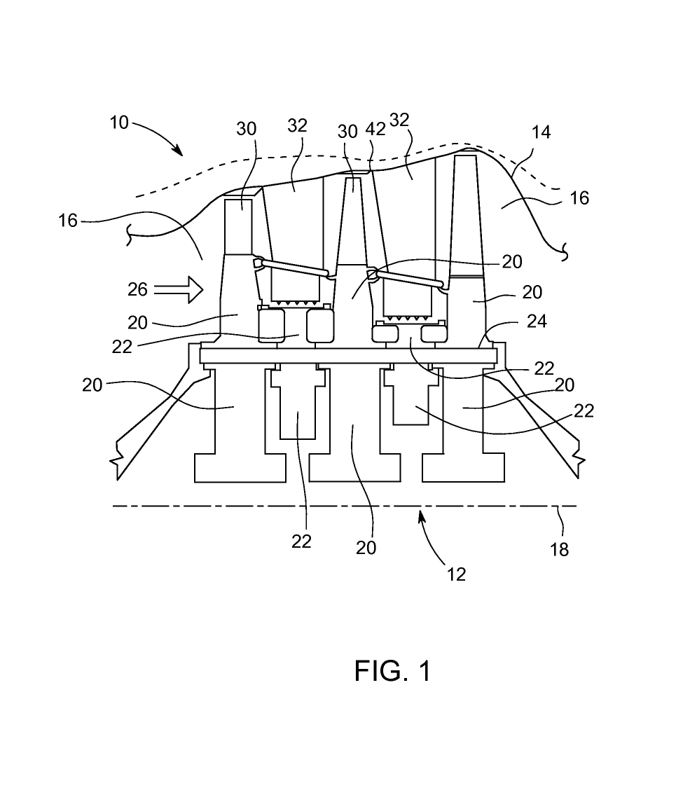

Referring now to the drawings, wherein identical numerals indicate the same elements throughout the figures, FIG. 1 provides a simplified side cross-section view of a portion of an embodiment of a turbine 10, which may incorporate embodiments of a rotor blade 30. As shown in FIG. 1, the turbine 10 generally includes a rotor 12 and a casing 14 that at least partially define a gas path 16 through the turbine 10. The rotor 12 is generally aligned with an axial centerline 18 of the turbine 10 and may be connected to a generator, a compressor, or another machine to produce work. The rotor 12 may include alternating sections of rotor wheels 20 and rotor spacers 22 connected together by a boll 24 to rotate in unison. The casing 14 circumferentially surrounds at least a portion of the rotor 12 to contain a compressed working fluid 26 flowing through the gas path 16. The compressed working fluid 26 may include, for example, combustion gases, compressed air, saturated steam, unsaturated steam, or a combination thereof.

As shown in FIG. 1, the turbine 10 further includes alternating stages of rotor blades 30 and stator vanes 32 circumferentially arranged inside the casing 14 and around the rotor 12 to extend radially between the rotor 12 and the casing 14. The rotor blades 30 may be connected to the rotor wheels 20 using various mechanical connections. In contrast, the stator vanes 32 may be peripherally arranged around the inside of the casing 14 opposite from the rotor spacers 22. Each rotor blade 30 and stator vane 32 generally has an airfoil shape, with a concave pressure side, a convex suction side, and leading and trailing edges. The compressed working fluid 26 flows along the gas path 16 through the turbine 10 from left to right as shown in FIG. 1. As the compressed working fluid 26 passes over the first stage of rotor blades 30, the compressed working fluid 26 expands, causing the rotor blades 30, rotor wheels 20, rotor spacers 22, bolt 24, and rotor 12 to rotate. The compressed working fluid 26 then flows across the next stage of stator vanes 32 which accelerate and redirect the compressed working fluid 26 to the next stage of rotor blades 30, and the process repeats for the following stages. In the embodiment shown in FIG. 1, the turbine 10 has two stages of stator vanes 32, between three stages of rotor blades 30; however, any number of stages may be employed for a particular purpose and the number of stages of rotor blades 30 and stator vanes 32 depicted in FIG. 1 is for illustrative purposes.

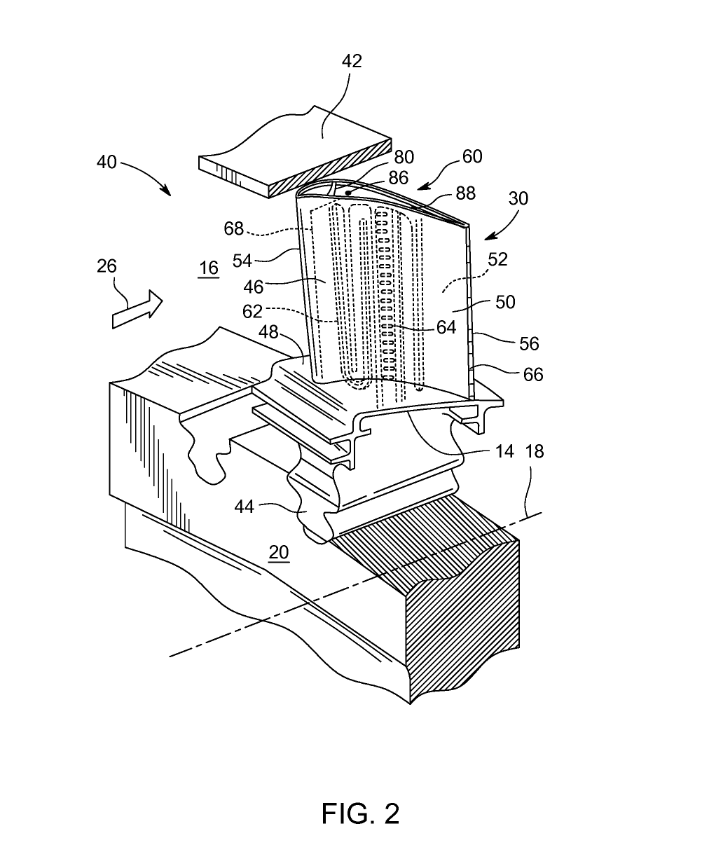

FIG. 2 provides a perspective view of a portion of an embodiment of a stage 40 of rotor blades 30 shown in FIG. 1 within the scope of the present invention. The stage 40 may be any stage in the turbine 10 downstream from a steam generator, combustor, or other system (not shown) that generates the compressed working fluid 26. As shown in FIGS. 1 and 2, an annular shroud 42 or plurality of shroud segments may be suitably joined to the casing 14 (not shown in FIG. 2) and surrounds the rotor blades 30 to provide a relatively small clearance or gap therebetween to limit leakage of the compressed working fluid 26 therethrough during operation. Each rotor blade 30 generally includes a dovetail 44 which may have any conventional form, such as an axial dovetail configured to slide in a corresponding dovetail slot in the perimeter of the rotor wheel 20. An airfoil 46 may be integrally joined to the dovetail 44 and may extend radially or longitudinally outwardly therefrom. The airfoil 46 may be hollow or substantially hollow. The rotor blade 30 may also include a platform 48, such as an integral platform 48, disposed at the junction of the airfoil 46 and the dovetail 44 for providing a radially inner portion of the compressed working fluid 26 flow path. The rotor blade 30 may be formed in a single or multi-piece casting or by other techniques.

The airfoil 46 generally includes a concave pressure surface 50 and a circumferentially or laterally opposite convex suction surface 52 that extend axially between a leading edge 54 and a trailing edge 56. The pressure and suction surfaces 50, 52 also extend in the radial direction between a radially inner root at the platform 48 and an outer radial end 60. The airfoil 46 extends in a spanwise direction from the platform 48 to the outer radial end 60, and extends in a streamwise direction from the leading edge 54 to the trailing edge 56. Further, the pressure and suction surfaces 50, 52 are spaced apart in the circumferential direction over the entire radial span of the airfoil 46 to define at least one internal flow chamber, channel, or cavity 62 for flowing a cooling media through the airfoil 46. The cooling media may include any fluid suitable for removing heat from the rotor blade 30, including, for example, saturated steam, unsaturated steam, or air. The cavity 62 may have any configuration, including, for example, serpentine flow channels with various turbulators therein for enhancing cooling media effectiveness, and the cooling media may be discharged through various holes through the airfoil 46, such as film cooling holes 64 and/or trailing edge discharge holes 66. The cavity 62 further includes a leading edge cavity 68 or other flag cavity adjacent the leading edge 54, which will be further described below.

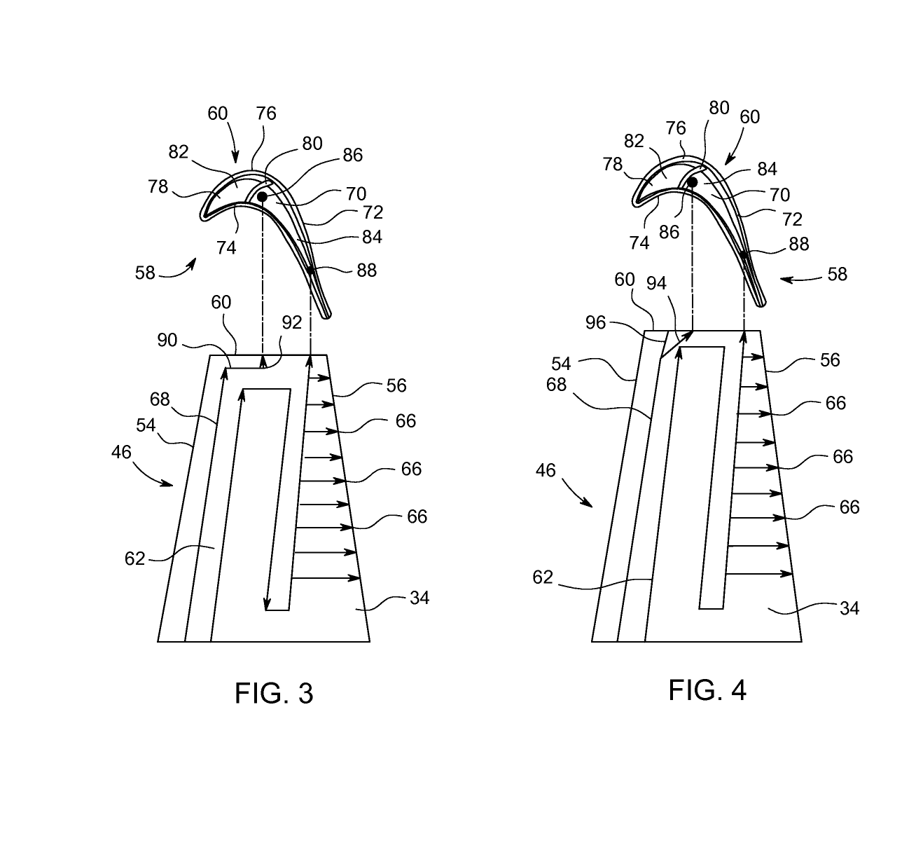

FIGS. 3 and 4 provide a schematic view of an embodiment of flow directions of a cooling media within an interior 34 of the airfoil 46 in comparison to a squealer tip 58 at the outer radial end 60 of the airfoil 46. In both FIGS. 3 and 4, a tip plate 70 extends across the outer radial end 60. The tip plate 70 may be integral to the rotor blade 30 or may be welded or otherwise secured into place at the outer radial end 60 of the airfoil 46. A rim 72 extends radially outward from the tip plate 70 to surround at least a portion of the airfoil 46. The rim 72 may include a concave side 74 opposed to a convex side 76. The concave side 74 extends radially outward from the concave surface 50 of the airfoil 46, and the convex side 76 extends radially outward from the convex surface 52 of the airfoil 46. Generally, the concave and convex sides 74, 76 will intersect with the tip plate 70 at approximately right angles, but this may vary in particular embodiments. In addition, the concave and convex sides 74, 76 may have approximately rectangular cross-sections, and the height and width of the concave and convex sides 74, 76 may vary around the tip plate 70, depending on various factors such as the location of the rotor blade, desired clearance with the shroud 42, etc. In particular embodiments, the concave and convex sides 74, 76 may join at the leading and trailing edges 54, 56 so that rim 72 surrounds the entire tip plate 70, as shown in FIGS. 3 and 4. A squealer tip pocket 78 between the concave and convex sides 74, 76 of the rim 72 and the tip plate 70 is thus provided at the outer radial end 60.

High pressure in the squealer tip pocket 78 requires higher pressures at supply conditions or other less desirable modifications to the geometry of the airfoil 46 to manage the high tip pressure. Thus, as further shown in FIGS. 3-4, a divider 80 extends across the tip plate 70 between the concave and convex sides 74, 76 to divide the squealer tip pocket 78 into a first pocket 82 for a high pressure section and a second pocket 84 for a low pressure section. Each pocket 82, 84 may be generally bound by the divider 80, the concave and convex sides 74, 76 of the rim 72, and the tip plate 70. In addition, the pockets 82, 84 are generally open through the outer radial end 60 of the rotor blade 30, and, upon installation, essentially become at least partially enclosed by the surrounding shroud 42.

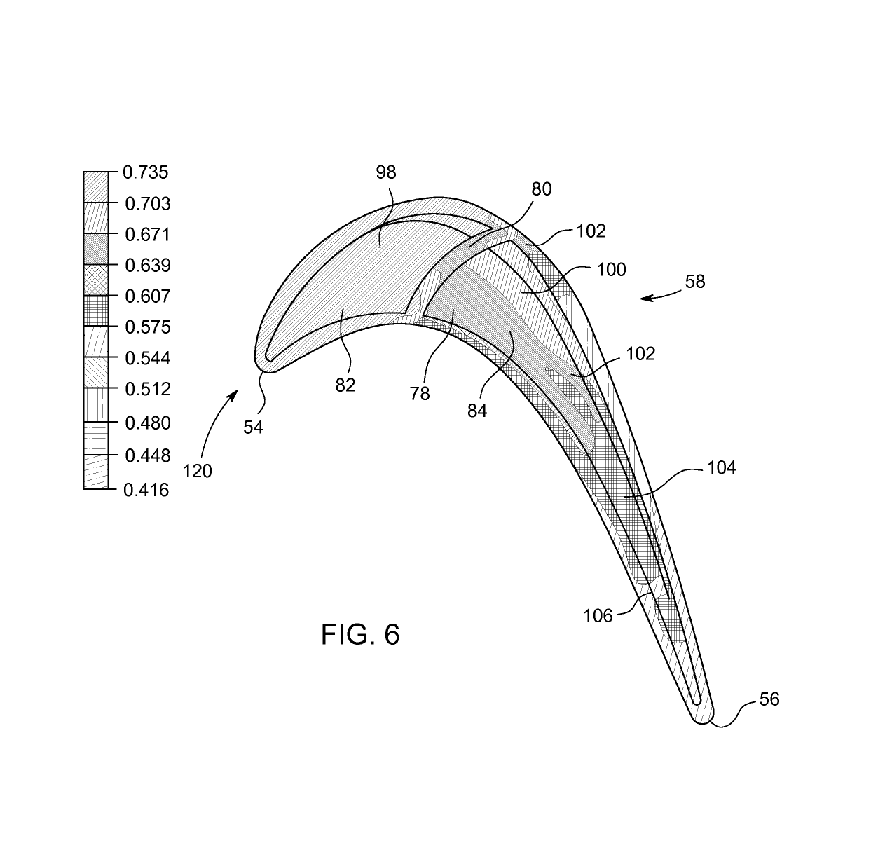

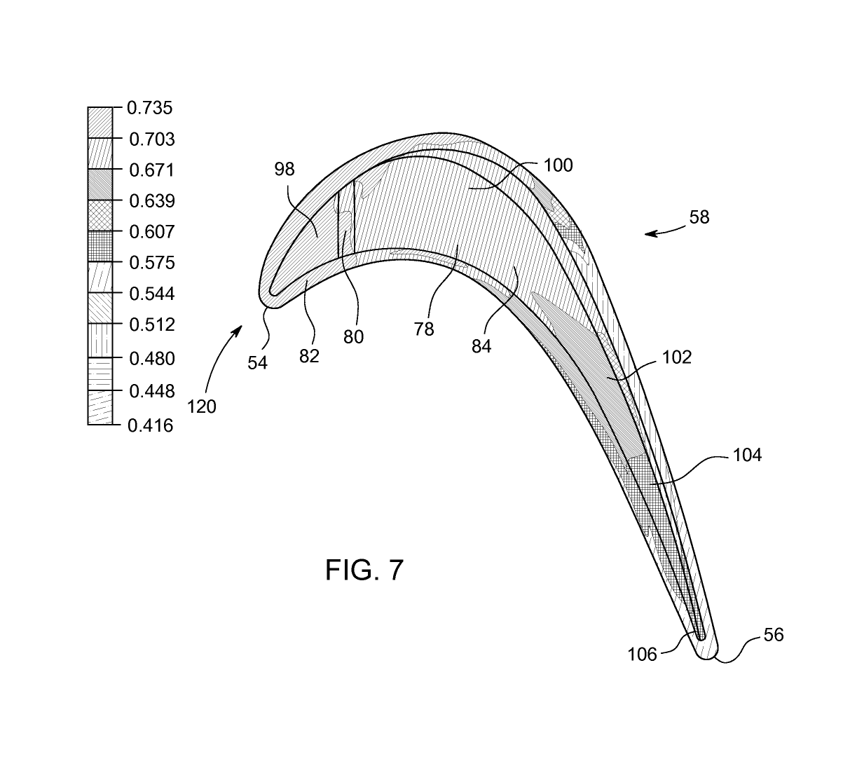

The pockets 82, 84 may vary in width, depth, length, and/or volume, particularly in the direction of the trailing edge 56; however, the placement of the divider 80 is selected to divide the squealer tip pocket 78 into a high pressure section within pocket 82 and a low pressure section within pocket 84, as will be further described below with respect to FIGS. 6 and 7. The depth of the pockets 82, 84 may be substantially constant across the tip plate 70, while the width of the pocket 84 may decrease in the direction of the trailing edge 56, generally narrowing in proportion to the narrowing shape of the airfoil 46 toward the trailing edge 56.

In particular embodiments, the tip plate 70, rim 72, and/or divider 80 may be treated with a coating; such as a bond coat or other type of high-temperature coating. The coating may include, for example, a corrosion inhibitor with a high aluminum content, such as an aluminide coating. Aluminide coatings are highly effective against corrosion, but tend to wear quickly. As a result, aluminide coatings are well suited for the interior of the pockets 82, 84 because this location is relatively sheltered from rubbing against adjacent parts.

The rotor blade 30 may further include a plurality of cooling passages 86, 88 that provide fluid communication through the tip plate 70 to the pocket 84, but not to the pocket 82. Although pocket 84 is positioned radially outwardly in the spanwise direction of the leading edge cavity 68 or other flag cooling cavity at the leading edge 54, fluid communication from the leading edge cavity 68, which would otherwise normally be delivered to the location of the tip plate 70 that corresponds to pocket 82, is redirected so as to communicate with passage 86 within the pocket 84 or other location in the pocket 84, thus accessing the low pressure section in pocket 84 as the pressure dump for the cooling cavity, thus managing tip pressure. The pocket 84 thus provides less pressure to work against for the fluid communication from the cavity 62 than the pocket 82. By providing cooling passages 86, 88 in the pocket 84 but not the pocket 82, this invention takes advantage of the behavior of the higher pressures found at the pocket 82. Using this arrangement provides low tip dump pressure, thus allowing the use of a lower compressor supply extraction to achieve desired flow. FIGS. 3 and 4 show two different embodiments for redirecting fluid communication from leading edge cavity 68 to the pocket 84. FIG. 3 illustrates a redirection flow path 90 that fluidically communicates the leading edge cavity 68 to a location further from the leading edge 54 and closer to the trailing edge 56. Then, a hole, opening, or aperture 92 fluidically connected to redirection flow path 90 is provided to communicate with the cooling passage 86. FIG. 4 illustrates an angled hole 94 that communicates the leading edge cavity 68 to the cooling passage 86. The angled hole 94 is also a redirection flow path in that it redirects fluid communication from the leading edge cavity 68 to a location further from the leading edge 54 and closer to the trailing edge 56. The airfoil 46 and tip plate 70 may further be plugged via plug 96 at a location that would otherwise fluidically communicate the leading edge cavity 68 towards the first pocket 82. The size and number of cooling passages 86, 88 in the pocket 84 is selected to deliver the desired pressure and flow rate of cooling media from the cavity 62 inside the airfoil 46 and into the pocket 84 to convectively and conductively cool the tip plate 70, rim 72, and divider 80 while also partially insulating these surfaces from the extreme temperatures associated with the compressed working fluid 26 flowing through the gas path 16.

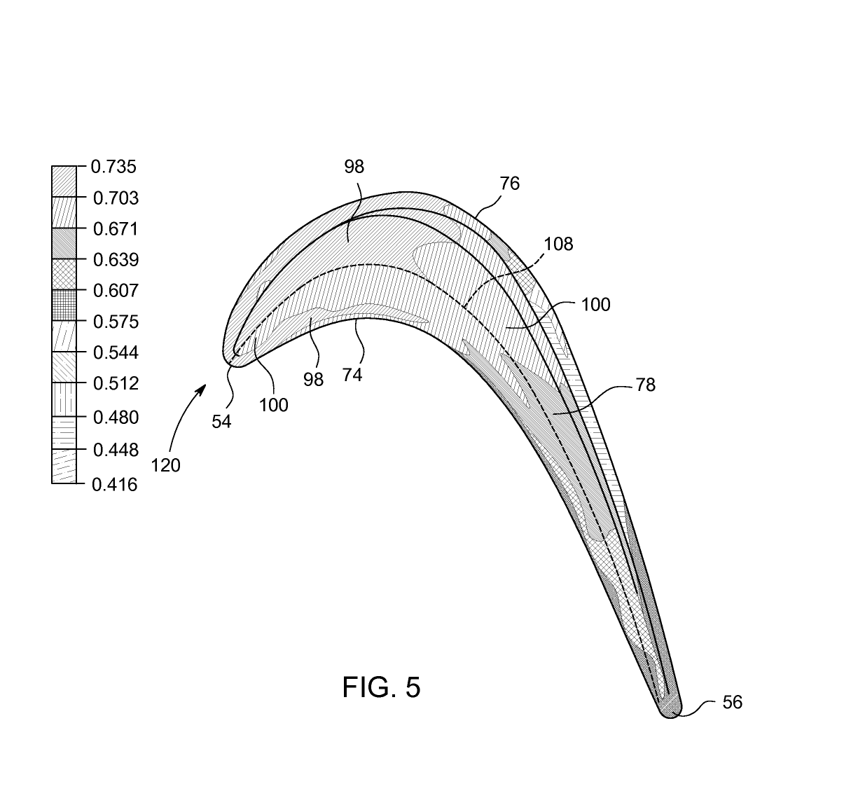

With reference now to FIGS. 5-7, an inlet pressure is measured at inlet 120, and a pressure along a camber line 108 (FIG. 5) of the squealer tip pocket 78 is measured. Variations in a ratio of the pressure within the squealer tip pocket 78 to total pressure at the inlet are illustrated. The pressure ratios are shown for demonstrative purposes only and are subject to change based on changes in component sizes, applications, and conditions. FIG. 5 demonstrates relative changes in the ratio as are encountered by providing no divider 80, and FIGS. 6-7 demonstrate relative changes in the ratio by changing the location of the divider 80 within the squealer tip pocket 78. FIG. 5 shows the squealer tip pocket 78 without a divider 80 therein. The highest ratio, and thus the highest pressure areas, are unevenly dispersed in various areas near the leading edge 54 and at both convex and convex sides 74, 76, as demonstrated by areas 98. Areas 100, having a lower pressure ratio then areas 98, are also spread fairly unevenly within the cavity 78. FIG. 6 shows the addition of the divider 80 within the squealer tip pocket 78. As can be seen, the highest ratio area 98 is concentrated within pocket 82, while the pocket 84 is exposed to lower ratio areas 102, 104, and 106, and a small amount of ratio area 100. FIG. 7 shows another embodiment of the squealer tip pocket 78 in which the divider 80 is provided closer to the leading edge 54 than in FIG. 6. Again, it is shown that the highest pressure ratio areas 98 are concentrated within the pocket 82.

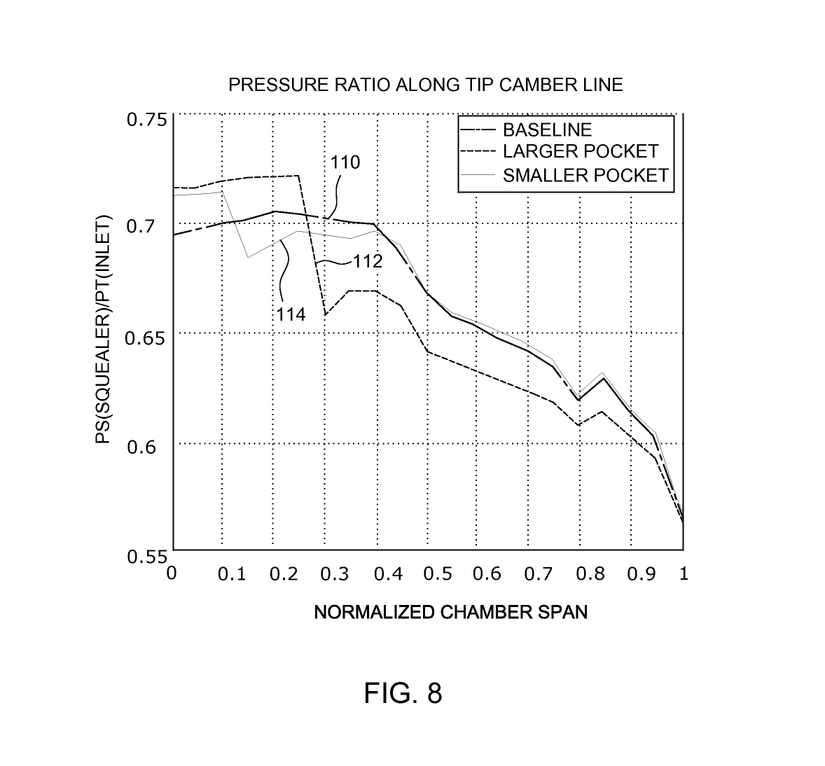

While the embodiment of FIG. 7 provides more room for the pocket 84 to accommodate cooling passages 86, 88 (as shown in FIGS. 3 and 4), the pocket 84 also contains a greater amount of pressure ratio areas 100 than does the embodiment of FIG. 6. Thus, optimum placement of the divider 80 within the squealer tip pocket 78 along camber line 108, which extends from the leading edge 54 to the trailing edge 56, may be selected to balance high pressure concentration within pocket 82 with maximizing the area of pocket 84. FIG. 8 demonstrates the pressure ratio Ps(squealer)/Pt(inlet) along the camber line 108, normalized chamber span, of the squealer tip 58 for each of the embodiments shown in FIGS. 5, 6, and 7, where “0” refers to the leading edge location of the camber line 108, and “1” refers to the trailing edge location of the camber line 108, with each position from left to right in the span indicating position of the camber line 108 in a streamwise direction. Line 110 in the chart refers to pressure ratio along the camber line 108 for the squealer tip of FIG. 5 having no divider, line 112 in the chart refers to pressure ratio along the camber line 108 for the squealer tip 58 of FIG. 6 having divider 80, and line 114 in the chart refers to pressure ratio along the camber line 108 for the squealer tip 58 of FIG. 7 having divider 80 positioned closer to the leading edge 54 than in FIG. 6. The change in pressure conditions affecting the squealer tip 58 is demonstrated by the position of the divider 80 at approximately location “0.15” for line 114 and approximately location “0.3” for line 112. FIG. 8 thus further demonstrates how the divider 80 creates a high (or at least higher) pressure section in pocket 82 and a low (or at least lower) pressure section in pocket 84. For balancing high pressure concentration within pocket 82 while maximizing the area of pocket 84, the location of the divider 80 may be positioned based on a static pressure ratio range of approximately 55 to approximately 75% of the upstream inlet average total pressure.

PS_{divider}/PTᵢₙₗₑₜ=0.55 to 0.75

Where PS_{divider} refers to the static pressure at the divider 80 and PTᵢₙₗₑₜ refers to the upstream inlet average total pressure, in other words the total pressure that passes around airfoil 46 at the leading edge 54 in the gas path 16, with inlet 120 illustratively depicted in FIGS. 5-7. For illustrative purposes only, the divider location for line 114 represents approximately 0.72 of PS_{divider}/PTᵢₙₗₑₜ and the divider location for line 112 represents approximately 0.66 of PS_{divider}/PTᵢₙₗₑₜ, which are within the range of 0.55 to 0.75. Thus, in these embodiments, the divider 80 is located somewhere between, or including, locations between what is shown in FIGS. 7 and 8. For example, the divider 80 may be placed approximately between 0.1 and 0.4 locations, and more particularly between 0.15 and 0.3 locations along camber line 108, where the high pressure pocket 82 spans 10-40% of the squealer tip cavity 78 from the leading edge 54 to the divider 80 measured along camber line 108, and more particularly 15-30% of the squealer tip cavity 78 from the leading edge 54 to the divider 80 measured along camber line 108. While particular examples have been described, as noted above, the divider may be located anywhere along the tip section at a static pressure ratio range PS_{divider}/PTᵢₙₗₑₜ=approximately 0.55 to approximately 0.75.

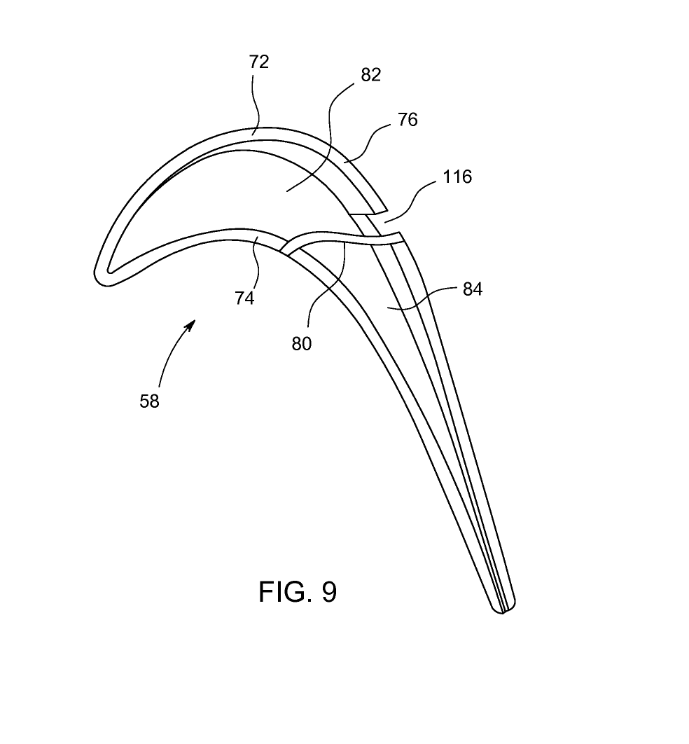

In an alternate embodiment as shown in FIG. 9, the rim 72 may include a fluid passage 116, such as a fluid passage 116 in the convex side 76 of the rim 72. Alternatively, the fluid passage 116 could be provided at an alternate location. The cooling passages 86, 88 are not shown but are further included in the second pocket 84 as shown in FIGS. 3 and 4.

From the embodiments shown and described with respect to FIGS. 1-9, a method of managing pressure at a tip 58 of an airfoil 46 is also provided. The method may include, for example, flowing the cooling media through the cooling passages 86, 88 and into the pocket 84 defined by the tip plate 70, rim 72, and divider 80. The method may further include blocking the cooling media from the pocket 82 separated from pocket 84 by divider 80. Blocking the cooling media from the pocket 82 may either be accomplished by plugging a cooling passage that would otherwise be directed into the pocket 82 or by redirecting the cooling fluid using redirected flow paths into the pocket 84.

Thus, various embodiments of the present invention include an airfoil 46 and a method for managing pressure at the tip 58 of the airfoil 46. The airfoil 46 includes a rim 72 that extends radially outward from a tip plate 70 at the outer radial end 60 to at least partially define a squealer tip pocket 78. A divider 80 extends across the tip plate 70 to separate the squealer tip pocket 78 into at least two pockets 82, 84, and a plurality of cooling passages 86, 88 provide fluid communication for a cooling media to flow through the tip plate 70 to lower pressure pocket 84. A fluid passage 116 in the rim 72 may provide fluid communication for the cooling media to flow across the rim 72 and out of one of the pockets 82, 84. Although embodiments of the present invention may be described generally in the context of a rotor blade 30 incorporated into a gas turbine 10 or other turbomachine, one of ordinary skill in the art will readily appreciate from the teachings herein that embodiments of the present invention are not limited to a gas turbine 10 or other turbomachine unless specifically recited in the claims.

The detailed description uses numerical and letter designations to refer to features in the drawings. Like or similar designations in the drawings and description have been used to refer to like or similar parts of the invention. As used herein, the terms “first,” “second,” and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An airfoil comprising:
a squealer tip at an outer radial end of the airfoil, a squealer tip pocket of the squealer tip having a convex side and a concave side;
a tip plate at the squealer tip;
a divider that extends across the tip plate from the concave side to the convex side to divide the squealer tip pocket into a first pocket and a second pocket; and,
at least one cooling passage through the tip plate in the second pocket to provide fluid communication through the tip plate from an interior of the airfoil to the second pocket;
wherein the first pocket is fluidically disconnected from the interior of the airfoil.

2. The airfoil of claim 1 including a camber line extending from a leading edge to a trailing edge of the airfoil, wherein the divider crosses the camber line of the airfoil.

3. The airfoil of claim 2, wherein a ratio of static pressure at the divider to an average total pressure at an inlet of the airfoil is approximately 0.55 to approximately 0.75.

4. The airfoil of claim 2, wherein the divider is positioned at a location along the camber line closer to the leading edge than the trailing edge.

5. The airfoil of claim 2, wherein the first pocket extends in a streamwise direction from the leading edge to approximately 10% to 40% along the camber line.

6. The airfoil of claim 1, further comprising a rim that extends radially outward from the tip plate and surrounds at least a portion of the tip plate, wherein the divider connects to the rim on the concave side and connects to the rim on the convex side.

7. The airfoil of claim 6, further comprising at least one fluid passage through the rim.

8. The airfoil of claim 7, wherein one fluid passage amongst the at least one fluid passage is adjacent the divider in the first pocket.

9. The airfoil of claim 1, wherein the tip plate in the first pocket is imperforate.

10. The airfoil of claim 1, wherein the at least one cooling passage includes a plurality of cooling passages.

11. The airfoil of claim 1, wherein the first pocket experiences higher pressures than the second pocket in use.

12. The airfoil of claim 1, further comprising a leading edge cavity within an interior of the airfoil, the first pocket axially aligned with and positioned radially outward of the leading edge cavity in a spanwise direction of the airfoil.

13. The airfoil of claim 12, further comprising a redirection flow path fluidically connecting the leading edge cavity to a cooling passage amongst the at least one cooling passage in the second pocket.

14. The airfoil of claim 12, wherein a cooling passage in the first pocket is plugged to prevent fluid communication between the leading edge cavity and the first pocket.

15. A rotor blade comprising:
a dovetail operatively configured to connect to a rotor wheel; and,
an airfoil including:
a squealer tip at an outer radial end of the airfoil, a squealer tip pocket of the squealer tip having a convex side and a concave side;
a tip plate at the squealer tip;
a divider that extends across the tip plate from the concave side to the convex side to divide the squealer tip pocket into a first pocket and a second pocket; and,
at least one cooling passage through the tip plate in the second pocket to provide fluid communication through the tip plate from an interior of the airfoil to the second pocket;
wherein the first pocket is fluidically disconnected from the interior of the airfoil.

16. The rotor blade of claim 15, wherein a ratio of static pressure at the divider to an average total pressure at an inlet of the airfoil is approximately 0.55 to approximately 0.75.

17. A method of managing pressure at a tip of an airfoil, the method comprising:
placing a divider across a tip plate in a squealer tip pocket of the airfoil from a concave side to a convex side of the tip to divide the tip pocket into a first pocket and a second pocket;
fluidically blocking an interior of the airfoil from the first pocket; and,
fluidically connecting at least one cooling passage through the tip plate in the second pocket to provide fluid communication through the tip plate from an interior of the airfoil to the second pocket.

18. The method of claim 17, wherein fluidically blocking the interior of the airfoil from the first pocket includes at least one of plugging a cooling passage in the first pocket from a leading edge cavity and fluidically connecting a pathway from the leading edge cavity to a cooling passage amongst the at least one cooling passage in the second pocket.

19. The method of claim 17, wherein placing the divider includes placing the divider where a ratio of static pressure at the divider to an average total pressure at an inlet of the airfoil is approximately 0.55 to approximately 0.75.

20. The method of claim 17, further comprising directing cooling air from the interior of the airfoil to the squealer tip pocket through lower pressures found in the second pocket and avoiding higher pressures found in the first pocket.
